(19) United States
(12) Patent Application Publication
(10) Pub. No.: US 2014/0213717 A1
(43) Pub. Date: Jul. 31, 2014

(54) Water repellant wood stains with improved weatherability

(71) Applicant: WACKER CHEMICAL CORPORATION, Adrian, MI (US)

(72) Inventors: Amanda Andrews, Petersburg, MI (US); Frank Sandmeyer, Burkirchen (DE); James D. Greene, Adrian, MI (US); Ricky W. Coffey, Adrian, MI (US)

(73) Assignee: Wacker Chemical Corporation, Adrian, MI (US)

(21) Appl. No.: 13/815,052

(22) Filed: Jan. 28, 2013

(51) Int. Cl. C09D 15/00

(52) U.S. Cl. CPC C09D 15/00
USPC 524/506; 524/500

(57) ABSTRACT

Woodstains of improved weatherability are prepared by incorporating polymer coated nanoparticles, and preferably at least one silicone, fluorocarbon, organosilane or wax water repellant into the woodstain.

### BACKGROUND OF THE INVENTION

1. Field of the Invention

The invention pertains to aqueous, water repellant and weatherable wood stains containing sub-micron sized, addition polymer-coated particles, and preferably at least one further water repellant.

2. Description of the Related Art

Wood products used in the home and in industry often have to be rendered water repellant while retaining a wood appearance, for example in interior uses in kitchens and bathrooms, and in particular, in outdoor uses such as wooden decks, pergolas, gazebos, aesthetic architectural elements, tables, chairs, and the like. Wood is subject to severe biological and photodegradation. Moist wood, in particular, is easily subject to attack through growth of molds, fungi, lichens, moss, etc. For centuries, coatings and penetrants have been sought to alleviate such “rot” of the wood. Railroad ties and landscaping timbers have been treated with creosote, for example, but this method of treatment is highly odiferous and easily transferred to persons or articles touching the creosoted wood.

Likewise, linseed oil, tung oil and other unsaturated oils have been used as penetrants, these oils slowly crosslinking over time. However, such penetrants rapidly use their effectiveness when exposed to the outdoors, and thus can generally only be used for indoor applications. Even so, unless covered with a relatively hard resin coating such as a varnish, even indoor effectiveness is lost over time.

Wood has also been pressure treated with inorganic salts, many of them toxic. However, the color of such products is frequently such that they are unable to be used in applications where aesthetics are important, and their use is now subject to environmental legislation. Chlorinated unsaturated compounds have also been used as water repelling preservatives. Here again, continued use is prohibited for environmental concerns.

Wax, alone or in combination with organopolysiloxanes (silicone oils), have also been used. Wax has the disadvantage that it is generally relatively easily degraded upon exposure to the elements, and silicone oils have the disadvantage that they are not fixed to the wood, but can continue to migrate slowly through the wood, reducing the surface concentration, which is the most critical for water penetration.

Water repellant coatings have been used on mineral as well as wood-based products for numerous years. However, the coatings must generally be tailored to the specific end product. Marble and granites, for example, are highly non-porous whereas limestone and sandstone have a wide range of porosity. Limestone is also relatively basic, which can require different chemistries in coatings. Wood, on the other hand, is always quite porous, is made from organic rather than inorganic constituents, and is subject to microbial attack which is not relevant to granite, for example. Wood is also generally mildly acidic, rather than basic.

So-called mineral based “architectural coatings” have also been used, sometimes as a protectant coating applied, for example at 200 g solids/m², or more thickly as a plaster, render, or stucco. Such coatings, with their high loading of fillers and pigments, should not be confused with a stain, which is applied at a much lower areal concentration and contains little filler or pigmentary material, or none at all. In stain applications, the wood is desired to have a “natural” appearance. Thus, for example, a water repellant for wood will generally be of low viscosity, free or substantially free of filler, and contain little or no dye or pigment. Wood stains, while still being free of filler, generally do contain dyes and/or pigments, with colors ranging from white to black, with brown and reddish shades being the most popular. Such water repellant coatings should not be confused with paints, however, which contain a much larger pigment loading, and wherein the pigments generally have a large particle size to provide opacity. While water repellant coatings are clear or translucent and penetrate below the surface, paints are opaque and have little or no surface penetration. Thus, the particle size of any (generally undesired) filler or pigment in water repellant coatings and stains must be less than in paints. In the present application, the term “wood stain” includes both colored (pigmented) wood stains and water repellant compositions, unless the latter terms are specifically used.

In U.S. published application 2008/0125536 A1, is disclosed a water repellant coating composition which contains a polybutylene wax, a methyl phenyl organopolysiloxane resin, an emulsifier, and water. The ability to use an aqueous dispersion is a distinct advantage over prior solvent-borne formulations due to the severe reduction in VOCs. Weatherability is somewhat improved by the use of a polyisobutylene. However, due to the quantity of polyisobutylene needed to produce high water repellency, this improvement is mostly lost. Thus, an improved coating system is desirable.

In U.S. Pat. No. 6,294,608, aqueous dispersions of long-chain alkyl alkoxy silanes in conjunction with aminoalkyl-functional silanes and siloxanes are used to impart hydrophobicity to masonry and wood products. However, the ability to formulate broadly with other ingredients, in particular pigments, is limited, as these may catalyze the hydrolysis of the alkoxy groups, leading to premature reaction or even gelling. While water repellency is markedly increased, the compositions do not block the pores, and thus water vapor transmission remains high. This can be a benefit in masonry products, where the masonry can “breathe,” but facilitates migration of water deeper into the wood in wood products where internal rot may occur. Of similar import is U.S. Pat. No. 5,962,585 which employs combinations of functional silanes and siloxanes with a high silicone content, in the form of a thick cream. Such products are not useful in wood stains.

It would be desirable to provide a wood stain which provides superior water repellency, even after weathering, and which exceeds the durability of conventional water repellant stains. It would be further desirable to provide a water repellant wood stain which allows for a natural “wood look,” without containing any substantial amounts of volatile organic compounds.

### SUMMARY OF THE INVENTION

The foregoing objects are surprisingly and unexpectedly achieved by an aqueous water repellant stain containing polymer coated nanoparticles and optionally but preferably, an organopolysiloxane, fluoropolymer, or wax. The stains are not only high in initial water repellency, but maintain that repellency over time, even outdoors, and even in high traffic areas.

### BRIEF DESCRIPTION OF THE DRAWINGS

FIG. 1 illustrates a walkway with planks stained with a conventional stain and an inventive stain.

FIG. 2 illustrates two planks of the walkway of FIG. 1 after 19 months of pedestrian traffic and weathering outdoors.

### DETAILED DESCRIPTION OF THE PREFERRED EMBODIMENT(S)

By “stain” is meant a coating which is transparent or partially opaque, but which contains a low pigment and filler loading, i.e. less than 10% by weight, preferably less than 5% by weight, and most preferably less than 2% by weight. The coating may be colored as desired, by relatively low levels of pigments, or with dyes. The pigments may be of any color, for example white, black, brown, yellow, red, blue, etc. In this respect, pigments should be distinguished from “fillers,” which may also have some pigmentary value but are added to increase body, provide opacity, and lower cost. Such fillers have generally larger particle sizes than pigments, for example in the range of 5 to 100 μm. Ground calcium carbonate is a common example of one such filler. Pigments, however, are in the very low μm range or in the nm range, providing color without opacity.

The polymer coated nanoparticles generally have sizes of 10 nm to 500 nm, more preferably 100 nm to 500 nm, yet more preferably 100-300 nm, and most preferably in the range of 100-200 nm. For each of these ranges, the recited numerical values include values close to the recited value but not including that value. For example, a range of ≧10 nm to ≦500 nm also fully discloses a range of >10 nm to <500 nm, etc.

The polymer coated particles have a particle core and a polymer shell. More than one polymer shell may be used, of the same or different polymers. The particle core may be any reactive particle of appropriate size, such that the final polymer-coated particles are within the previously mentioned range. Thus smaller particles may require a thicker polymer coating, and vice versa. Particle size may range, for example from 5 μm to 200 μm, but both larger and smaller particles are useful. By “reactive” is meant that the particles are reactive with the monomers subsequently polymerized to form the polymer shell, through covalent bonding.

The particle core consists of an inorganic particle or a particle of silicone resin or solid organopolysiloxane. Preferred inorganic particles are, for example, but not by limitation, fumed, colloidially produced, or finely ground, e.g. and milled particles of metal oxides, silicates, etc., so long as the particle is reactive in the sense that it acquires a firmly bound polymer coating during additional polymerizable monomer polymerization. Thus, for example, silicone resins of the conventional MT, MQ, T, MQT, MDT, MDQ, DT, DTQ, and MDTQ types are suitable. In these resins, which are commercially available, the definition of M, D, T, and Q units is conventional and follows the terminology of Noll, Chemistry and Technology of Silicones, Academic Press, New York, c 1968, pp. 3 to 7. In these resins, the “R” group, as in R₂SiO_{3/2} “T” units and R₂SiO_{2/2} “D” units may be any organofunctional group, such as alkyl, alkenyl, or aryl groups, alkoxy or hydroxyl groups.

The inorganic particles and silicone resin particles which comprise the core must have, or must be modified to have multiple carbon-carbon bond unsaturation, which is most preferably ethylenic unsaturation. Thus, particles of silicone resin which are produced by a cohydrolysis wherein unsaturated alkoxy or chlorosilanes are present, e.g. vinyltrimethoxysilane and vinyldimethylmethoxysilane, may inherently contain such unsaturation due to their preparation. Silicone resins bearing, for example, hydroxy groups, may be reacted with an isocyanate-functional silane such as isocyanatomethyldimethylvinylsilane to provide ethylenic unsaturation. However, reaction with an alkoxy functional silane such as vinyltrimethoxysilane through condensation is also effective. In like manner, inorganic particles are “silanized” with a reactive silane bearing carbon-carbon unsaturation, or by other means to include such unsaturation.

The particles are then coated by polymerizing additional polymerizable monomers, either in solution or suspension, i.e. by emulsion polymerization, to form the polymer shell. The addition curable monomers may grow from the unsaturated carbon-carbon bonds or the particle core, or may subsequently be grafted onto the core.

The silanizing agents used to react with the particles when necessary may be any reactive silane bearing a carbon-carbon unsaturated group, but is preferably an α-silane as methacrylatomethyltrimethoxysilane, although other silanes such as the more conventional methacryloxypropyltrimethoxysilane may also be used. The use of α-silane functionalizing agents is preferred.

The polymer coated nanoparticles are, in a preferred embodiment, copolymers of ethylenically unsaturated monomers and of ethylenically functionalized nanoparticles in the form of their aqueous polymer dispersions or water-redispersible polymer powders, obtainable by means of free-radically initiated polymerization in an aqueous medium and, if desired, subsequent drying of the resultant polymer dispersion of

A) one or more monomers from the group consisting of vinyl esters, (meth)acrylic esters, vinylaromatics, olefins, 1,3-dienes, vinyl ethers and vinyl halides and, if desired, further monomers copolymerizable therewith, in the presence of
B) at least one particle P having an average diameter of less than or equal to 1000 nm, which is functionalized with ethylenically unsaturated, free-radically polymerizable groups, wherein
B1) the particles P are one or more particles from the group of metal oxides and semimetal oxides, and/or B2) the particles P are silicone resins composed of repeating units of the general formula [R⁴_{(p+z)}SiO_{(4-p-z)/2}] (II), each R⁴ being identical or different and denoting hydrogen, hydroxyl, or alkyl, cycloalkyl, aryl, alkoxy or aryloxy radicals each having up to 18 carbon atoms and optionally substituted, where for at least 20 mol % of the respective silicone resin p+z=0, 1 or 3,
and where B1) and B2) are each preferably functionalized with one or more α-organosilanes of the general formula (R¹O)₃₋ₙ(R²)ₙSi—(CR³₂)—X (I), where R¹ is hydrogen, an alkyl radical having 1 to 6 carbon atoms or an aryl radical, R² and R³ each independently of one another are hydrogen, an alkyl radical having 1 to 12 carbon atoms or an aryl radical, n can be 0, 1 or 2 and X is a radical having 2 to 20 hydrocarbon atoms and containing an ethylenically unsaturated group. The particles P may also be solid organopolysiloxanes which are not resins. Such organopolysiloxanes are generally of high molecular weight, and are often branched.

Suitable vinyl esters are those of carboxylic acids having 1 to 15 carbon atoms. Preference is given to vinyl acetate, vinyl propionate, vinyl butyrate, vinyl-2-ethylhexanoate, vinyl laurate, 1-methylvinyl acetate, vinyl pivalate and vinyl esters of α-branched monocarboxylic acids having 9 to 11 carbon atoms, examples being VeoVa9^{R} and VeoVa10^{R} (trade names of Resolution). Vinyl acetate is particularly preferred.

Suitable monomers from the group of acrylic esters or methacrylic esters are esters of unbranched or branched alcohols having 1 to 15 carbon atoms. Preferred methacrylic esters or acrylic esters are methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, tert-butyl acrylate, tert-butyl methacrylate, 2-ethylhexyl acrylate and norbornyl acrylate. Particular preference is given to methyl acrylate, methyl methacrylate, n-butyl acrylate, isobutyl acrylate, tert-butyl acrylate, 2-ethylhexyl acrylate, and norbornyl acrylate.

Preferred vinylaromatics are styrene, alpha-methylstyrene, the isomeric vinyltoluenes and vinylxylenes, and divinylbenzenes. Styrene is particularly preferred.

The vinyl halogen compounds include vinyl chloride, vinylidene chloride, and also tetrafluoroethylene, difluoroethylene, hexylperfluoroethylene, 3,3,3-trifluoropropene, perfluoropropyl vinyl ether, hexafluoropropylene, chlorotrifluoroethylene and vinyl fluoride. Vinyl chloride is particularly preferred.

An example of a preferred vinyl ether is methyl vinyl ether.

The preferred olefins are ethene, propene, 1-alkylethenes and polyunsaturated alkenes, and the preferred dienes are 1,3-butadiene and isoprene. Particular preference is given to ethene and 1,3-butadiene.

If desired it is additionally possible to copolymerize 0.1% to 5% by weight of auxiliary monomers, based on the total weight of the monomers A). It is preferred to use 0.5% to 2.5% by weight of auxiliary monomers. Examples of auxiliary monomers are ethylenically unsaturated monocarboxylic and dicarboxylic acids, preferably acrylic acid, methacrylic acid, fumaric acid and maleic acid; ethylenically unsaturated carboxamides and carbonitriles, preferably acrylamide and acrylonitrile; monoesters and diesters of fumaric acid and maleic acid such as the diethyl and diisopropyl esters; maleic anhydride; ethylenically unsaturated sulphonic acids and their salts, preferably vinylsulphonic acid and 2-acrylamido-2-methylpropanesulphonic acid. Further examples are pre-crosslinking comonomers such as polyethylenically unsaturated comonomers, examples being divinyl adipate, diallyl maleate, allyl methacrylate or triallyl cyanurate, or post-crosslinking comonomers, examples being acrylamidoglycolic acid (AGA), methylacrylamidoglycolic acid methyl ester (MAGME), N-methylolacrylamide (NMA), N-methylolmethacrylamide, N-methylolallylcarbamate, alkyl ethers such as the isobutoxy ether or esters of N-methylolacrylamide, of N-methylolmethacrylamide and of N-methylolallylcarbamate. Also suitable are epoxy-functional comonomers such as glycidyl methacrylate and glycidyl acrylate. Mention may also be made of monomers containing hydroxyl or CO groups, examples being hydroxyalkyl methacrylates and acrylates such as hydroxyethyl, hydroxypropyl or hydroxybutyl acrylate or methacrylate and also compounds such as diacetoneacrylamide and acetylacetoxyethyl acrylate or methacrylate. It is also preferred in some applications to avoid the use of auxiliary monomers.

Particularly preferred comonomers A) are one or more monomers from the group of vinyl acetate, vinyl esters of α-branched monocarboxylic acids having 9 to 11 carbon atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, styrene and 1,3-butadiene. Particularly preferred comonomers A) are also mixtures of vinyl acetate and ethylene; mixtures of vinyl acetate, ethylene and a vinyl ester of α-branched monocarboxylic acids having 9 to 11 carbon atoms; mixtures of n-butyl acrylate and 2-ethylhexyl acrylate and/or methyl methacrylate; mixtures of styrene and one or more monomers from the group of methyl acrylate, ethyl acrylate, propyl acrylate, n-butyl acrylate and 2-ethylhexyl acrylate; mixtures of vinyl acetate and one or more monomers from the group of methyl acrylate, ethyl acrylate, propyl acrylate, n-butyl acrylate, 2-ethylhexyl acrylate and, if desired, ethylene; mixtures of 1,3-butadiene and styrene and/or methyl methacrylate. The stated mixtures may, if desired, additionally include one or more of the abovementioned auxiliary monomers.

The monomer selection and/or the selection of the weight fractions of the comonomers is or are made so as to result in general in a glass transition temperature, Tg, of 60° C., preferably −50° C. to +60° C. The glass transition temperature Tg of the polymers can be determined in a known way by means of differential scanning calorimetry (DSC). The Tg values may also be calculated approximately in advance by means of the Fox equation. According to Fox T. G., Bull. Am. Physics Soc. 1, 3, page 123 (1956): 1/Tg=x1/Tg1+x2/Tg2+ . . . +xn/Tgn, where xn is the mass fraction (% by weight/100) of the monomer n and Tgn is the glass transition temperature, in kelvins, of the homopolymer of the monomer n. Tg values for homopolymers are listed in Polymer Handbook 2nd Edition, J. Wiley & Sons, New York (1975).

The fraction of the comonomers A is preferably 50% by weight, more preferably 70% to 90% by weight, based in each case on the total weight of A) and functionalized B).

Suitable particles P include particles from the group B1) of silicas and metal oxides. The metal oxides are preferably the oxides of the metals aluminium, titanium, zirconium, tantallum, tungsten, hafnium, zinc and tin. Among the silicas, particular preference is given to colloidal silica, pyrogenic or fumed silica, precipitated silica, or silica sols. Among the metal oxides, particular preference is given to aluminas such as corundum, mixed oxides of aluminium with other metals and/or silicon, titanium oxides, zirconium oxides and iron oxides.

Preferred particles P from the group of the silicone resins include those composed of at least 30 mol % of Q units, in other words for which p+z in the general repeating formula [R⁴_{(p+z)}SiO_{(4-p-z)/2}] (II) is 0. Particularly preferred silicone resins are those composed only of M and Q units, in other words for which p+z in the general formula [R⁴_{(p+z)}SiO_{(4-p-z)/2}] (II) are defined as 0 and 3, respectively. If the radicals R⁴ are substituted, then they may additionally contain one or more identical or different heteroatoms selected from O, S, Si, Cl, F, Br, P or N atoms. Also suitable, furthermore, are silicone resins composed of an arbitrary combination of M units (R₃SiO—), D units (—OSiR₂O—), T units (RSiO₃³⁻) and Q units (SiO₄⁴⁻), with the proviso that T units and/or Q units are always present and that their fraction as a proportion of the units of which the silicone resin is composed totals at least 20 mol % and, where only one of these units is present, its fraction is at least 20 mol %.

Silicone resins B2) most preferred are those composed essentially only of M and Q units, the molar ratio of M/Q units ranging from 30/70 to 60/40, with particular preference being given to resins having an M/Q ratio of 35/65 to 45/55. Resins most preferred are, in addition, those composed predominantly of T units, particularly those composed of >80 mol % T units, and most preferably those composed of virtually 100 mol % of T units.

The particles P preferably possess an average diameter of 1 to 1000 nm, more preferably 1 to 100 nm, the particle size being determined by transmission electron microscopy on the resulting dispersions or on the films obtainable from the dispersions. A range of 10 to 300 nm is particularly preferred.

By α-organosilanes are meant those silanes in which the alkoxy-, aryloxy- or OH-substituted silicon atom is connected directly via a methylene bridge to an unsaturated hydrocarbon radical which has one or more ethylenically unsaturated carbon bonds, it also being possible for the hydrogen radicals of the methylene bridge to be replaced by alkyl and/or aryl radicals, and there is a C═C double bond positioned a to the Si atom.

Suitable α-organosilanes of the formula (R¹O)₃₋ₙ(R²)ₙSi—(CR³₂)—X (I) are also those in which the carbon chains of the radicals R′, R² and R³ are interrupted by non-adjacent oxygen, sulphur or NR⁴ groups. Preferred radicals R¹ and R² are unsubstituted alkyl groups having 1 to 6 carbon atoms and preferred radical R³ is hydrogen. The radical X may be linear, branched or cyclic. Besides the double bond there may also be further functional groups present, which are generally inert with respect to an olefinic polymerization, examples being halogen, carboxyl, sulphinato, sulphonato, amino, azido, nitro, epoxy, alcohol, ether, ester, thioether and thioester groups and also aromatic isocyclic and heterocyclic groups. Preferred examples of X are monounsaturated C₂ to C₁₀ radicals; maximum preference as radical X is given to the acryloyl and methacryloyl radicals.

The weight fraction of the functionalized particles P in the aqueous dispersion of nanoparticles as prepared is preferably 0.5% to 50% by weight, more preferably 1% to 30% by weight, and most preferably 10% to 20% by weight, based in each case on the total weight of component A) and of the functionalized component B).

In addition, the polymer dispersions and polymer powders useful in the stains of the invention may further contain up to 30% by weight, based on the total weight of components A) and B), of at least one silane of the general formula (R⁵)₄₋ₘ—Si—(OR⁶)ₘ (III), where m is a number of 1, 2, 3 or 4, R⁵ is an organofunctional radical selected from the group of alkoxy radicals and aryloxy radicals, each having 1 to 12 carbon atoms, phosphonic monoester radicals, phosphonic diester radicals, phosphonic acid radicals, methacryloxy radicals, acryloxy radicals, vinyl radicals, mercapto radicals, isocyanato radicals, the isocyanato radical optionally being reversibly blocked for protection against chemical reactions, the hydroxyl radical, hydroxyalkyl radicals, epoxy radicals, glycidyloxy radicals, morpholino radicals, piperazino radicals, primary, secondary or tertiary amino radicals having one or more nitrogen atoms, it being possible for the nitrogen atoms to be substituted by hydrogen or by monovalent aromatic, aliphatic or cycloaliphatic hydrocarbon radicals, carboxylic acid radicals, carboxylic anhydride radicals, aldehyde radicals, urethane radicals, urea radicals, it being possible for the radical R⁵ to be attached directly to the silicon atom or to be separated therefrom by a carbon chain of 1 to 6 carbon atoms, and R⁶ being a monovalent linear or branched aliphatic or cycloaliphatic hydrocarbon radical or a monovalent aromatic hydrocarbon radical having in each case 1 to 12 carbon atoms, or a radical —C(═O)—R⁷, R⁷ being a monovalent linear or branched aliphatic or a cycloaliphatic hydrocarbon radical having in each case 1 to 12 carbon atoms or a monovalent aromatic hydrocarbon radical. The selected silane or, if desired, the selected silanes may be present in a non-hydrolysed form, in hydrolysed form or in hydrolysed and part-condensed or hydrolysed and condensed form, or in a mixture of these forms.

In the case of miniemulsion polymerization, furthermore, it is possible, if desired, for hydrophobic additives to be present in amounts of up to 10% by weight (referred to as “co-surfactants” or “hydrophobes”), based on the total weight of component A) and of functionalized component B). In the present case it is often possible for silicone particles to take on the function of the “co-surfactant”. Further examples of co-surfactants are hexadecane, cetyl alcohol, oligomeric cyclosiloxanes such as octamethylcyclotetrasiloxane, and also vegetable oils such as rapeseed oil, sunflower oil or olive oil. Additionally suitable are organic or inorganic polymers having a number-average molecular weight of <10,000. Inventively preferred hydrophobes are the silicone particles for polymerization themselves, and also D3, D4 and D5 cyclosiloxanes and hexadecane. Particular preference is given to the silicone particles to be polymerized, and to hexadecane.

The copolymers are prepared in a hetero-phase operation in accordance with the known techniques of the suspension, emulsion or miniemulsion polymerization (cf. e.g. Peter A. Lovell, M. S. El-Aasser, “Emulsion Polymerization and Emulsion Polymers”, 1997, John Wiley and Sons, Chichester). In one particularly preferred form the reaction is carried out in accordance with the methodology of miniemulsion polymerization. Miniemulsion polymerizations differ in a number of key points, which make them particularly suitable for copolymerizing water-insoluble comonomers, from other heterophase polymerizations (cf. e.g. K. Landfester, “Polyreactions in Miniemulsions”, Macromol. Rapid. Commun. 2001, 22, 896-936 and M. S. El-Aasser, E. D. Sudol, “Miniemulsions: Overview of Research and Applications”, 2004, JCT Research, 1, 20-31).

The reaction temperatures are generally at 0° C. to 200° C., preferably from 5° C. to 100° C., more preferably 5° C. to 80° C., and most preferably 30° C. to 70° C. The pH of the dispersing medium is generally between 2 and 9, preferably between 4 and 8. In one particularly preferred embodiment it is between 6.5 and 7.5. Adjustment of pH before the beginning of the reaction can be made by means of hydrochloric acid or sodium hydroxide solution. The polymerization may be conducted batch wise or continuously, with all or some constituents of the reaction mixture being included in the initial charge, with some constituents of the reaction mixture being included partly in the initial charge and partly metered in subsequently, or by the metering process without an initial charge. All metered additions are made preferably at the rate at which the component in question is consumed.

The polymerization is initiated by means of the customary water-soluble initiators or redox initiator combinations. Examples of initiators are the sodium, potassium and ammonium salts of peroxodisulphuric acid, hydrogen peroxide, tert-butyl peroxide, tert-butyl hydroperoxide, potassium peroxodiphosphate, tert-butyl peroxopivalate, cumene hydroperoxide, isopropylbenzene monohydroperoxide and azobisisobutyronitrile. The initiators are preferably used in amounts of 0.01% to 4.0% by weight, based on the total weight of the monomers. Redox initiator combinations used may include abovementioned initiators in conjunction with a reducing agent. Suitable reducing agents are sulphites and bisulphites with monovalent cations, examples being sodium sulphite, the derivatives of sulphoxylic acids such as zinc or alkali metal formaldehyde-sulphoxylates, an example being sodium hydroxymethanesulphinate, and ascorbic acid. The amount of reducing agent is preferably 0.15% to 3% by weight of the monomer amount used. In addition it is possible to introduce small amounts of a metal compound which is soluble in the polymerization medium and whose metallic component is redox-active under the polymerization conditions, being based for example on iron or on vanadium. One particularly preferred initiator system comprising the aforementioned components is the system tert-butyl hydroperoxide/sodium hydroxymethane-sulphinate/Fe(EDTA)^{2+/3+}.

In the case of a reaction regime in accordance with the miniemulsion polymerization methodology it is also possible to use predominantly oil-soluble initiators, such as cumene hydroperoxide, isopropylbenzene monohydroperoxide, dibenzoyl peroxide or azobisisobutyronitrile. Preferred initiators for miniemulsion polymerizations are potassium persulphate, ammonium persulphate, azobisisobutyronitrile and dibenzoyl peroxide.

The dimensions of the particle domains within the copolymer after copolymerization has taken place are preferably in the range from 1 nm to 1000 nm, more preferably from 1 nm to 500 nm and most preferably 10 nm to 200 nm. The dimensions can be determined by means for example of scanning electron microscopy or transmission electron microscopy on the polymer dispersions or on the polymer films obtained from them.

To produce water-redispersible polymer powders, the aqueous dispersions of the copolymers are dried in a manner known to one skilled in the art, preferably by the spray drying method. However, in the case of the present invention, the polymer coated particles may be used directly for water repellent stain formulation as a dispersion.

The organopolysiloxanes useful in the stains of the present invention are preferably non-volatile organopolysiloxanes comprising D units, terminated with M units. A low amount of T units and Q units, generally in amounts of less than 10 mol percent, more preferably lower than 5 mol percent, may be present. Most preferably, the organopolysiloxanes contain no Q units, and only a minor amount of T units, if at all, and thus may be described as linear or lightly branched organopolysiloxanes. These organopolysiloxanes are liquid, and can be distinguished from organopolysiloxane resins by their mostly complete lack of three dimensional crosslinking due to the low proportion of T and Q units, which are necessary to produce an organopolysiloxane resin. Most preferably, the organopolysiloxanes are linear.

The organopolysiloxanes may be non-functional, e.g. the various R groups in the M and D units, and T units if present, are conventional alkyl, cycloalkyl, aryl, arylalkyl, or alkaryl groups, these groups generally containing up to 20 carbon atoms, more preferably up to 18 carbon atoms. For alkyl groups, from 1 to 18 carbons is preferable, and more preferably, most alkyl groups are C₁₋₄ alkyl groups. The methyl group is particularly preferred. Long chain alkyl groups, especially C₈₋₁₈ alkyl groups may be present to confer additional hydrophobicity. Preferred aryl groups contain 6-10 carbon atoms, and preferred arylalkyl and alkaryl groups preferably contain 7-14 carbon atoms. Preferred aryl groups are phenyl and napthyl, preferred arylalkyl groups are benzyl groups, and preferred alkaryl groups are tolyl groups.

The organopolysiloxanes may also contain functional groups. Preferred functional groups include silicon-bonded hydroxyl groups (silanol groups) and silicon-bonded alkoxy groups, preferably C₁₋₄ alkoxy groups, and most preferably methoxy and ethoxy groups. Such functional groups can provide two complementary functions: bonding covalently by condensation with the hydroxyl-rich wood fibers, and crosslinking following application to form a crosslinked polymer. Both of these functions decrease the ability of the organopolysiloxane to migrate deeper into the wood, losing surface effectiveness, or to overly exude from the surface of the wood, rendering it oily.

Other functional groups include organic groups bearing epoxy functionality, such as glycidoxy groups, ethylenic unsaturation, such as (meth)acryloyloxy or vinyl groups, urethane groups, urea groups, cyano groups, and aminoalkyl groups. Of the latter, 3-aminopropyl and N-(2-aminoethyl)-3-aminopropyl groups are most preferred. In the case of aminoalkyl-functional organopolysiloxanes, the amine number, the number in millilitres of 1N HCl necessary to neutralize the polymer, is preferably between 0.01 and 1, more preferably between 0.1 and 0.5.

The organopolysiloxanes may also include carbon bonded polyoxyalkylene ether groups or silicon bonded polyxoyalkylene ether groups, poly(etherurethane) groups, and the like.

The molecular weight of the organopolysiloxane polymers is not particularly critical, as long as they are essentially non-volatile at temperatures below about 70° C., or the highest temperature expected under full sunshine in summer exposure. Molecular weights of from 500 g/mol to about 500,000 g/mol are preferred. The upper limit of molecular weight is generally that which provides organopolysiloxanes which are neither solid nor wax-like in character.

However, this upper limit may be extended if reactive or non-reactive diluents are employed together with the organopolysiloxanes, for example paraffinic solvents or low molecular weight organopolysiloxanes. High molecular weight organosiloxanes which are in gum or elastomer solid or semisolid form, i.e. with no diluent present, are less likely to penetrate below the surface of the wood product being stained. Some minimal degree of penetration is desired. The organopolysiloxanes are preferably employed in amounts of from 0.01 to 10 weight percent, relative to the total weight of the stain composition, more preferably from 0.05 to 5 weight percent, yet more preferably 0.1 to 2 weight percent, and most preferably about 0.5 to 1.5 weight percent.

Organosilanes are also useful as ingredients in the inventive formulation. Such silanes are monomeric, or if hydrolysable, may be used in partly hydrolysed form, and allow for crosslinking through condensation following application of the stain, for added anchoring (coupling) of the remaining ingredients to the wood fibers, or for adding additional wafer repellancy. These silanes are reactive silanes which contain silicon-bonded alkoxy or hydroxyl groups, preferably alkoxy groups. Preferred alkoxy groups are methoxy and ethoxy groups. The unhydrolyzed silanes thus correspond to the formula

(R′O)ₙR″₄₋ₙSi

where n is 1, 2, or 3, R′ is an organo group, preferably an alkyl group, and most preferably a C₁₋₄ alkyl group, and R″ is a carbon-silicon bonded organo group, preferably an alkyl group, and most preferably a C₁₋₁₈ alkyl group. When more than one R″ is present, it is preferable that at least one W′ be a long chain alkyl group, preferably a C₈₋₁₈ alkyl group. Octyl groups and isoctyl groups are most preferred. Silanes containing aminoalkyl groups, e.g. where at least one R″ is an aminopropyl or N-(2-aminoethyl)-3-aminopropyl group are also preferred. An example is N-(2-aminoethyl)-3-aminopropylmethyldimethoxysilane.

The silanes or their partial hydrolysates can be present in an amount of 0.01 to 5 weight percent, relative to total stain weight, more preferably 0.01 to 2 weight percent, and yet more preferably 0.1 to 1.5 weight percent.

Further ingredients may be added to provide or to further increase water repellancy, durability, or other properties. For example, fluoro-polymers, particularly fluoro-substituted organopolysiloxanes may be added to increase water repellancy but also, if desired, to improve oil-staining resistance. Fluoro-containing waxes and polymers may also be used. The amounts of fluoro-polymers which are useful are preferably 0.1 to 5 weight percent based on the total weight of the stain, more preferably 0.2 to 2 weight percent, and most preferably 0.2 to 1.5 weight percent.

Polyolefin waxes and natural waxes, generally in the form of a fine aqueous dispersion, may also be added. Such wax emulsions are commercially available, and generally consist of fine particle size dispersions of oligomeric polyethylene homopolymers, polyethylene copolymers, polypropylenes, polybutylenes, including polymers of 1-butene and 2-butene, and copolymers thereof, with or without additional comonomers, etc. When waxes are employed, the amounts are preferably in the range of 0.1 to 10 weight percent, based on total stain weight, more preferably 0.2 to 5 weight percent, yet more preferably 0.1 to 3 weight percent, and most preferably, 0.5 to 1.5 weight percent. Although waxes are generally weatherable, their presence serves to increase initial beading and water repellancy. Surprisingly, in the inventive compositions, waxes do not suffer from weatherability as in other formulations.

Inorganic nanoparticles can be added to the formulation to increase dirt repellancy and to increase UV stability. The inorganic nanoparticles may be dispersed in a polyorganosiloxane fluid, reactive or non-reactive, prior to addition to the formulation, or may be incorporated in solid form, or otherwise. The amount of inorganic nanoparticles, based on stain weight, is preferably from about 0.01 to 10 weight percent, more preferably 0.05 to 5 weight percent, yet more preferably 0.1 to 2 weight percent, and most preferably 0.2 to 1 weight percent. Preferred inorganic nanoparticles are metal oxides such as zinc oxide and titanium dioxide.

It is noted that the claimed composition is described as an additive, and its composition in parts or weight percent is relative to total solids of the additive composition. However, each component of the additive composition may be added separately to the stain. In other words, it is not necessary that all components be in a single composition. The composition may be supplied as separate components, as two or more sub-assemblies of various components, or as a single additive, and the claims should be so interpreted unless expressed to the contrary.

The stains of the present invention thus have incorporated into them, in weight percentages based on total stain weight, from 0.1 to 75%, more preferably 0.5 to 60%, yet more preferably 1 to 40%, and especially about 10% of polymer-coated nanoparticles (as solids); and about 15 weight percent or less, preferably about 10% or less, more preferably 0.1 to 5 weight percent, still more preferably 0.5 to 4 weight percent, and most preferably 1 to 3 weight percent of at least one organopolysiloxane, wax, or fluoropolymer, the latter weight percents being relative to the ingredients separately, the total not exceeding 100%, preferably not exceeding, in order of increasing preference, not more than 80%, 70%, 60%, and 50%. The amounts preferably provide a water repellent efficiency of at least 60% as measured by Swellometer testing on Ponderosa pine, more preferably in order of increasing preference, 70%, 80%, and 90% or more. Preferred stains contain organopolysiloxane, wax, and in addition, a silane.

In terms of composition based on use of an additive to an existing or new stain requiring improvement of weatherability, the weatherability-improving compositions contain the polymer-coated nanoparticles, and preferably at least one fluoropolymer, wax, or organopolysiloxane, the latter three ingredients present in an amount, relative to polymer-coated nanoparticle solids, of 1-50 weight percent, more preferably 5-40 weight percent, yet more preferably 10-30 weight percent, and most preferably 15-25 weight percent. The relative proportions of each of these ingredients which are preferred can be calculated from the corresponding ranges disclosed in the specification for these ingredients based on total stain weight, converted to percentages based on polymer-coated nanoparticle weight. The polymer-coated nanoparticles may be added in powder form, i.e. as a redispersible powder, or in aqueous dispersion. It is preferred that the remaining ingredients be present in the form of an aqueous emulsion, and it is most preferred that all components be in the same emulsion. The ingredients may also be provided separately, in kit form.

### EXAMPLES

The polymer-coated nanoparticle stains of the invention were tested on Southern yellow pine boards for water absorption before and after UV exposure with a Xenon U.V. lamp as is customary for accelerated weathering tests. The stains were also tested on an exposed decking of Southern yellow pine maintained as an outdoor walkway in Adrian, Mich., thus being exposed to hot and cold outdoor conditions as well as pedestrian traffic.

The stain base used is a published formulation, prepared as follows. In a dispermat mixer, 55.19 parts Avanse ST-410 acrylic resin (37% non-volatiles) available from Dow Chemical was agitated while slowly adding 24.32 parts deionized water at 1000 s⁻¹, together with 0.98 parts Tego™ Foamex 805 defoamer, 0.24 parts Surfynol™ 104 DPM surfactant, 1.51 parts propylene glycol, and Rozone™ 2000 mildewcide. Following 10 minutes of mixing, a premix of 0.57 parts Tinuvin™ 1130 and Tinuvin™ 292, available from Ciba, was added and mixed for two minutes. Next, 0.35 parts Tint-Ayd™ CW-5600 red tint and 0.76 parts Tint-Ayd™ CW-5499 yellow tint were added and mixed for 10 minutes, followed by admixing 13.39 parts deionized water for five minutes, and gradually mixing in 0.87 parts Acrysol™ RM-8w available from Dow Chemical as a rheology modifier. The stain was then mixed for ten minutes further.

The examples employed the following components (“sub-assemblies”):

### Component 1

Polymer coated silicone resin nanoparticles were prepared by copolymerizing in aqueous media a comonomer mixture of 691.46 parts butyl acrylate, 504.73 parts methyl methacrylate, 220.86 parts butyl methacrylate, 125.69 parts styrene, and 34.79 parts methyl styrene, onto 294.7 parts of an MDTQ resin, supplied to the polymerization reactor as 60 weight percent resin in butyl acrylate. The emulsion polymerization took place in 1050.12 parts deionized water, with 56.45 parts sodium dodecyl sulfate as emulsifier, in the presence of 8.63 parts hydroquinone monomethyl ether, and 12.57 parts hexadecane.

### Component 2

A silane and organopolysiloxane aqueous emulsion containing a blend of non-ionic surfactants, deionized water, 53 weight percent linear polydimethyl siloxanes with N-(2-aminoethyl-3-aminopropyl) functional groups, and silanol groups having a viscosity of 1000 mPa·s and an amine equivalent number of 0.3, about 1% N-(2-aminoethyl-3-aminopropyl)methyldimethoxysilane, and a minor amount of isothiazolinone biocide.

### Component 3

A wax and silicone resin aqueous emulsion containing about 35 weight percent polyisobutylene copolymer at 100% solids, about 12 weight percent of a liquid, solventless, methoxy-functional methyl, phenyl polysiloxane, oleic acid, triethanol amine, a 4,4′-dimethyloxazolidine biocide and water, as disclosed in U.S. published application. 20080125536.

### Component 4

A surfactant-stabilized aqueous silane and fluropolymer emulsion containing about 24 weight percent of a mixture of octyltriethoxysilane and isooctyltrimethoxy silane, about 31 weight percent fluoropolymer emulsion, and a minor amount of biocide.

### Component 5

A silane and organopolysiloxane aqueous emulsion containing a blend of non-ionic surfactants, deionized water, 53 weight percent linear polydimethyl siloxanes with N-(2-aminoethyl-3-aminopropyl) functional groups and silanol groups, having a viscosity of 4000 mPa·s and an amine equivalent number of 0.15, about 1% N-(2-aminoethyl-3-aminopropyl)methyldimethoxysilane, and a minor amount of isothiazolinone biocide.

A series of formulations were prepared by homogenously blending the above ingredients, as indicated in Table 1. Examples 1-7 (Example 1 is a Comparative Example) use the stain base described previously. Examples 8-16 employed a commercially available stain.

TABLE 1

| | | Formulation | | | | | | | | | |
|---|---|---|---|---|---|---|---|---|---|---|---|
| Example: | Ref | C1 | 2 | 3 | 4 | 5 | 6 | 7 | 8 | 9 | 10 |
| Component 1 | 0 | 25 | 25.5 | 51 | 76.5 | 103.5 | 20 | 20 | 22.5 | 22.5 | 20 |
| Component 2 | 0 | — | — | — | — | — | — | — | — | 1.75 | 2.5 |
| Component 3 | 0 | — | — | — | — | — | — | 5 | — | — | — |
| Component 4 | 0 | — | — | — | — | — | — | — | 2.5 | 1.75 | — |
| Polymer Wax[1] | 0 | — | — | — | — | — | 5 | — | — | — | — |
| Inorganic Nanoparticle[2] | 0 | — | — | — | — | — | — | — | — | — | 2.5 |
| Component 5 | 0 | — | — | — | — | — | — | — | — | — | — |
| Stain | 250 | 225 | 224.5 | 199 | 173.5 | 146.5 | 225 | 225 | 225 | 225 | 225 |
| Swellometer % water | 20.2 | 37 | 77 | 82 | 90 | 85 | 74.2 | 64.4 | 62.5 | 67.1 | 58.0 |
| repellency efficiency | | | | | | | | | | | |

| | Formulation | | | | | | | | | |
|---|---|---|---|---|---|---|---|---|---|---|
| Example: | 11 | 12 | 13 | 14 | 15 | 16 | 17 | 18 | 19 | 20 |
| Component 1 | 22 | 22.5 | 22.5 | 22.5 | 22.5 | 20 | 20 | 20 | 20 | 22.5 |
| Component 2 | — | — | 2.5 | — | 1.75 | — | 2.5 | 2.5 | 2.5 | 2.5 |
| Component 3 | — | — | — | — | — | — | — | — | — | — |
| Component 4 | — | — | — | — | — | — | 1.25 | — | 2.5 | — |
| Polymer Wax[1] | — | — | — | 2.5 | 1.75 | — | — | — | — | — |
| Inorganic Nanoparticle[2] | — | 0.5 | — | — | — | 5 | 1.25 | — | — | — |
| Component 5 | 3 | 2 | — | — | — | — | — | 2.5 | — | — |
| Stain | 225 | 225 | 225 | 225 | 225 | 225 | 225 | 225 | 225 | 225 |
| Swellometer % water | 61.3 | 99.2 | 89.9 | 90.9 | 99.4 | 91.3 | 93.3 | 90.3 | 83.0 | 99.6 |
| repellency efficiency | | | | | | | | | | |

Boards were tested for water absorption by swellometer testing in accordance with ASTM D4446. In each test, Ponderosa pine sapwood panels were used. Each panel was immersed into stain for three minutes, blotted, and dried for seven days prior to testing. In each test, two adjacent panels, one stained and one not stained were immersed in water for 30 minutes to measure water uptake or water repellency efficiency. A desired water efficiency is 60% or higher. The results are presented in Table 1 above.

The results in Table 1 show that at low concentration, the silicon-coated nanoparticles are not very effective alone. The swellometer water repellant efficiency was only 37%, whereas for a board treated with only stain and no additives, the value is 20%. However, higher concentrations of polymer-coated nanoparticles increase the water repellency efficiency above the swellometer passing rate of 60% or higher. This result is particularly surprising since a very sharp cut-off between unacceptable water repellency and effective water repellency occurs, as shown by comparing Comparative Example C1 with Example 2. Without wishing to be bound to any particular theory, it is estimated that this sharp cut-off is due to a critical amount of polymer-coated nanoparticles which is necessary to block the wood pores effectively, which may vary somewhat with different species of wood. When wax, fluoropolymer, or silicone is added, even in relatively small amounts, the water efficiency virtually doubles with low concentrations of polymer-coated nanoparticles which is highly surprising and unexpected. The best results are obtained when a silicone is present as well as the polymer-coated nanoparticles and either or both of wax and fluorpolymer.

Suitable formulations and ingredient ranges are presented below in formulations A-N.

| Formulation A | % Range |
|---|---|
| Stain | 60-98 |
| Component 1 | 1-35 |
| Wax | 1-5 |
| Total | |

| Formulation B | % Range |
|---|---|
| Stain | 60-98 |
| Component 1 | 1-30 |
| Component 3 | 1-10 |
| Total | 100 |

| Formulation C | % Range |
|---|---|
| Stain | 60-98 |
| Component 1 | 1-30 |
| Component 4 | 1-10 |
| Total | 100 |

| Formulation D | % Range |
|---|---|
| Stain | 60-97 |
| Component 1 | 1-30 |
| Component 2 | 1-5 |
| Component 4 | 1-5 |
| Total | 100 |

| Formulation E | % Range |
|---|---|
| Stain | 60-97 |
| Component 1 | 1-30 |
| Component 2 | 1-5 |
| Inorganic Nanoparticles | 1-5 |
| Total | 100 |

| Formulation F | % Range |
|---|---|
| Stain | 60-98 |
| Component 1 | 1-30 |
| Component 5 | 1-10 |
| Total | 100 |

| Formulation G | % Range |
|---|---|
| Stain | 60-97 |
| Component 1 | 1-30 |
| Inorganic Nanoparticle | 1-5 |
| Component 5 | 1-5 |
| Total | 100 |

| Formulation H | % Range |
|---|---|
| Stain | 60-98 |
| Component 1 | 1-35 |
| Component 2 | 1-5 |
| Total | 100 |

| Formulation I | % Range |
|---|---|
| Stain | 60-98 |
| Component 1 | 1-30 |
| Wax | 1-10 |
| Total | 100 |

| Formulation J | % Range |
|---|---|
| Stain | 60-97 |
| Component 1 | 1-30 |
| Component 2 | 1-5 |
| Wax | 1-5 |
| Total | 100 |

| Formulation K | % Range |
|---|---|
| Stain | 60-98 |
| Component 1 | 1-35 |
| Inorganic Nanoparticle | 1-5 |
| Total | 100 |

| Formulation L | % Range |
|---|---|
| Stain | 60-97 |
| Component 1 | 1-30 |
| Component 4 | 1-5 |
| Inorganic Nanoparticle | 1-5 |
| Total | 100 |

| Formulation M | % Range |
|---|---|
| Stain | 60-97 |
| Component 1 | 1-30 |
| Component 2 | 1-5 |
| Component 5 | 1-5 |
| Total | 100 |

| Formulation N | % Range |
|---|---|
| Stain | 50-80 |
| Component 1 | 20-50 |
| Total | 100 |

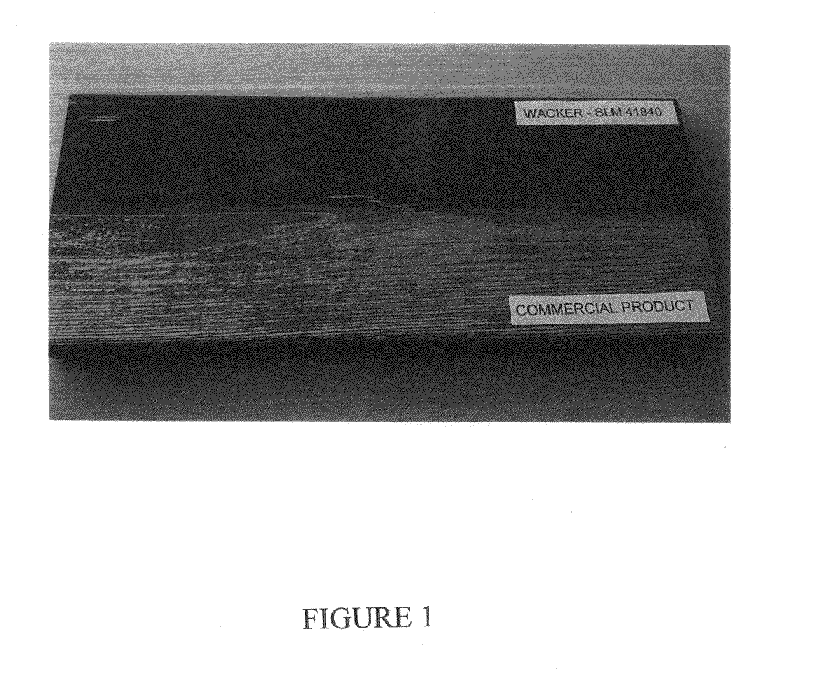

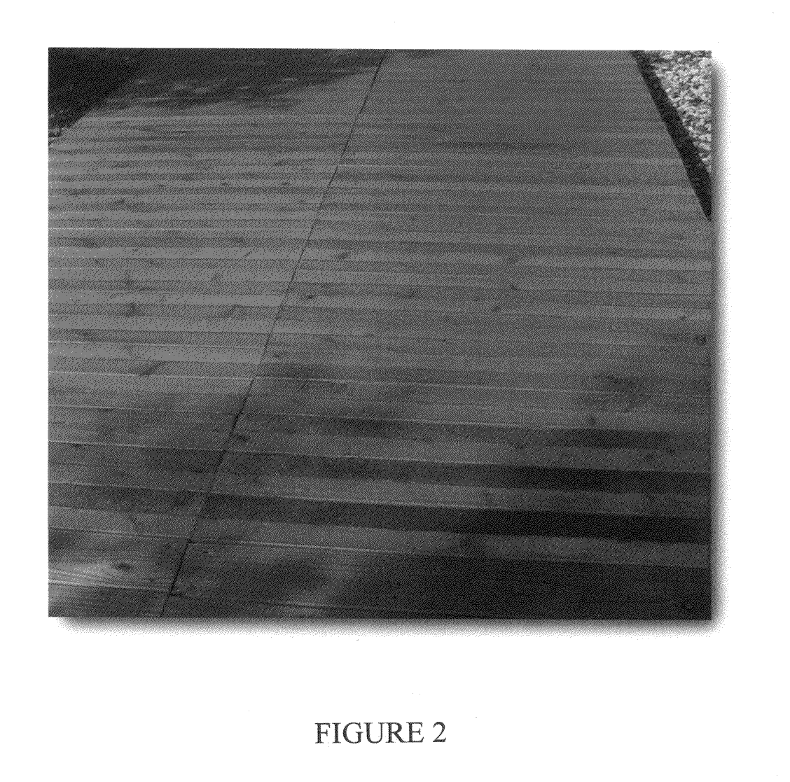

A wooden walkway of preservative treated Southern yellow pine was stained, half of each wooden plank in the lengthwise direction having been painted with the base stain, the other half painted with an inventive stain containing 25 weight percent of component 1. Pictures were taken following staining and after 19 months of pedestrian traffic and outdoor exposure. FIG. 1 illustrates the walkway shortly after staining, while FIG. 2 illustrates the improvement in wear and weatherability achieved with the inventive formulation. The improvement is striking, particularly in view of the limited amount of the inventive composition in the stain.

Also, deck boards have been stained with all the formulations above. With the same description with formulation 2 to stain the top half of the boards and formulations 3-20 on the bottom half of boards. All the boards proceed to exhibit high water repellency, good weatherability, and resistance to traffic.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for increasing the weatherability of an aqueous wood stain for application to substrates comprising wood, comprising applying to the wood a wood stain which comprises,
a) polymer-coated nanoparticles which are copolymers of ethylenically unsaturated monomers and ethylenically functionalized nanoparticles, obtained by free radically polymerizing
a)i) solid particles of an inorganic oxide, organopolysiloxane, silicone resin or mixture thereof, functionalized to contain ethylenically unsaturated groups, with
a)ii) at least one ethylenically unsaturated monomer selected from the group consisting of vinyl esters, (methylacrylate esters, vinylaromatics, vinyl halides, olefins, and 1,3-dienes, and
b) optionally, at least one water repellant selected from the group consisting of organopolysiloxanes, waxes, fluoropolymers, and silanes,
wherein when component b) is not present, component a) is present in an amount sufficient to achieve a water repellency efficiency swellometer value of 60 or more.

2. The claim of claim 1, wherein the polymer-coated nanoparticles are present in an amount of from 0.01% to 75%, based on the polymer-coated nanoparticles as solids, relative to the total weight of the stain.

3. The method of claim 1, wherein a fluoropolymer is incorporated, in an amount of from 0.01 to 15 weight percent, based on the weight of the stain.

4. The method of claim 1, wherein a wax is incorporated, in an amount of from 0.01 to 15 weight percent based on the total weight of the stain.

5. The method of claim 1, wherein an organopolysiloxane is incorporated, in an amount of from 0.01 to 15 weight percent.

6. The method of claim 1, wherein at least two of a fluoropolymer, a wax, and an organopolysiloxane are incorporated, the total amount of fluropolymer, wax, and organopolysiloxane being from 0.01 to 15 weight percent based on the weight of the stain.

7. The method of claim 1, further comprising incorporating inorganic nanoparticles into the stain.

8. An aqueous wood stain comprising an organic polymer dispersion and optionally one or more pigments, and further comprising a weatherability increasing component comprising:
a) at least one aqueous dispersion comprising polymer-coated nanoparticles which are copolymers of ethylenically unsaturated monomers and ethylenically functionalized nanoparticles, obtained by free radically polymerizing
a)i) solid particles of an inorganic oxide, organopolysiloxane, silicone resin or mixture thereof, functionalized to contain ethylenically unsaturated groups, with
a)ii) at least one ethylenically unsaturated monomer selected from the group consisting of vinyl esters, (methylacrylate esters, vinylaromatics, vinyl halides, olefins, and 1,3-dienes, and
b) optionally, at least one water repellant selected from the group consisting of organopolysiloxanes, waxes, fluoropolymers, and organosilanes.

9. The aqueous wood stain of claim 8, wherein the polymer-coated nanoparticles are present in an amount of from 0.01% to 75, based on the polymer-coated nanoparticles as solids, relative to the total weight of the stain.

10. The aqueous wood stain of claim 8, wherein a fluoropolymer is incorporated, in an amount of from 0.01 to 15 weight percent, based on the weight of the stain.

11. The aqueous wood stain of claim 8, wherein a wax is incorporated, in an amount of from 0.01 to 15 weight percent based on the total weight of the stain.

12. The aqueous wood stain of claim 8, wherein an organopolysiloxane is incorporated, in an amount of from 0.01 to 15 weight percent.

13. The aqueous wood stain of claim 8, wherein at least two of a fluoropolymer, a wax, and an organopolysiloxane are incorporated, the total amount of fluropolymer, wax, and organopolysiloxane being from 0.01 to 15 weight percent based on the weight of the stain.

14. The aqueous wood stain of claim 8, further comprising incorporating inorganic nanoparticles into the stain.

15. A weatherability-improving composition suitable for incorporation into an aqueous wood stain, comprising
a) at least one aqueous dispersion comprising polymer-coated nanoparticles which are copolymers of ethylenically unsaturated monomers and ethylenically functionalized nanoparticles, obtained by free radically polymerizing
a)i) solid particles of an inorganic oxide, organopolysiloxane silicone resin or mixture thereof, functionalized to contain ethylenically unsaturated groups, with
a)ii) at least one ethylenically unsaturated monomer selected from the group consisting of vinyl esters, (methylacrylate esters, vinylaromatics, vinyl halides, olefins, and 1,3-dienes, and
b) at least one water repellant selected from the group consisting of organopolysiloxanes, waxes, fluoropolymers, and organosilanes.

16. The composition of claim 15, which contains at least one organosilane.

17. The composition of claim 15, wherein the total of fluoropolymer, wax, and organopolysiloxane is from 1 to 50 weight percent, based on the total weight as solids of the polymer-coated nanoparticles.

18. The composition of claim 15, wherein a wax and an organopolysiloxane are both present, a silane is optionally present, and inorganic nanoparticles are optionally present.

19. The composition of claim 18, wherein a wax, an organopolysiloxane, and a silane are present.

20. The composition of claim 18, wherein a wax, an organopolysiloxane, a silane, and inorganic nanoparticles are present.
